(19) United States
(12) Patent Application Publication
(10) Pub. No.: US 2025/0259664 A1
(43) Pub. Date: Aug. 14, 2025

(54) PHYSICAL UNCLONABLE FUNCTION CIRCUIT, SECURITY CIRCUIT HAVING THE SAME, AND METHOD OF OPERATING THE SAME

(71) Applicant: SAMSUNG ELECTRONICS CO., LTD., Suwon-si (KR)

(72) Inventors: Kilho LEE, Suwon-si (KR); Daeshik Kim, Suwon-si (KR); Yongjae Kim, Suwon-si (KR)

(73) Assignee: SAMSUNG ELECTRONICS CO., LTD., Suwon-si (KR)

(21) Appl. No.: 18/796,957

(22) Filed: Aug. 7, 2024

(30) Foreign Application Priority Data
Feb. 8, 2024 (KR) 10-2024-0019932

(51) Int. Cl. G11C 11/16

(52) U.S. Cl. CPC G11C 11/1695; G11C 11/161; G11C 11/1673; G11C 11/1675

(57) ABSTRACT

A physical unclonable function (PUF) circuit is implemented using a Magnetoresistive Random Access Memory (MRAM) and generating an internal magnetic field to reduce a stray field of target cells. A random number is generated in the target cell by controlling a voltage applied to the target cells.

### CROSS-REFERENCE TO RELATED APPLICATION

This application claims the benefit under 35 USC 119(a) of Korean Patent Application No. 10-2024-0019932 filed on Feb. 8, 2024 in the Korean Intellectual Property Office, the entire disclosure of which is incorporated herein by reference for all purposes.

### BACKGROUND

Embodiments are related to a physical unclonable function circuit, a security circuit having the same, and a method of operating the same.

Generally, SOT-MRAM (Spin Orbit Torque Magnetoresistive Random Access Memory) is a type of magnetic memory device. SOT-MRAM offers advantages such as low power consumption, high speed, long-term data retention, and durability compared to other traditional memory technologies. Electrons possess a quantum property known as spin, which determines how electrons respond to magnetic fields and plays a crucial role in magnetic memory devices. Spin-Orbit Interaction represents the interaction between the spin and orbital motion of electrons, which is one of the key principles of SOT-MRAM. SOT-MRAM utilizes spin-orbit interaction to control the magnetic spin polarity of electrons. Electrons can have either up or down spin polarities, which can be represented as 0 and 1. When an external electric field or current is applied, the magnetic spin polarity is altered through spin-orbit interaction, allowing for the storage, reading, and writing of data. SOT-MRAM possesses excellent data retention capabilities, enabling it to meet long-term data storage requirements.

### SUMMARY

Example embodiments provide a physical unclonable function circuit generating good quality random numbers, a security circuit having the same, and a method of operating the same.

Provided herein is a method of operating a physical unclonable function circuit using Magnetoresistive Random Access Memory (MRAM) includes generating an internal magnetic field to reduce a stray field of target cells; and generating a random number in the target cells by controlling a voltage applied to the target cells.

Also provided herein is a physical unclonable function circuit including: a plurality of variable resistance cells, wherein each of the plurality of variable resistance cells includes: a Spin-Orbit Torque (SOT) line (SOT line) connected to a corresponding source line, wherein the SOT line is configured to be provided with a wordline voltage; a free layer formed on top of the SOT line; a tunnel barrier formed on top of the free layer; and a pinned layer formed on top of the tunnel barrier, and wherein a state of each of target cells may be determined in a state that an internal magnetic field is generated to reduce a stray field of the target cells among the plurality of variable resistance cells.

Also provided herein is a security circuit including: a physical unclonable function circuit configured to generate a random number; and a processor configured to generate a key using the random number, wherein the physical unclonable function circuit includes a PUF block, the PUF block includes a plurality of variable resistance cells connected to bitlines, source lines, read wordlines, and write wordlines, each of the plurality of variable resistance cells includes, a Spin-Orbit Torque (SOT) line (SOT line) connected to a corresponding source line among the source lines, wherein the SOT line is configured to be provided with a wordline voltage; a free layer formed above the SOT line; a tunnel barrier formed on top of the free layer; and a pinned layer formed on top of the tunnel barrier, and wherein a state of each of target cells may be determined in a state that an internal magnetic field is generated to reduce a stray field of the target cells among the plurality of variable resistance cells.

Also provided herein is an electronic device including: a host device configured to generate a challenge for an authentication operation; and an integrated circuit configured to generate a response corresponding to the challenge, wherein the integrated circuit is configured to receive the challenge, to generate a random number corresponding to an internal challenge, and to generate the response corresponding to the random number, wherein the random number is generated from a plurality of variable resistance cells, and wherein a state of each of target cells may be determined in a state that the integrated circuit is configured to generate an internal magnetic field to reduce a stray field of target cells among the plurality of variable resistance cells.

### BRIEF DESCRIPTION OF DRAWINGS

The above and other aspects, features, and advantages of embodiments will be more clearly understood from the following detailed description, taken in conjunction with the accompanying drawings, in which:

FIG. 1 is a diagram illustrating a security device according to example embodiments;

FIG. 2 is a diagram illustrating a PUF circuit according to example embodiments;

FIG. 3 is a diagram illustrating a variable resistance cell according to example embodiments;

FIG. 4 is a diagram illustrating the presence of a stray field in a general PUF circuit;

FIG. 5 is a diagram illustrating stray field removal by generating an internal magnetic field in a PUF circuit according to example embodiments, by way of example;

FIG. 6 is a diagram illustrating the removal of stray fields by generating a magnetic field in a PUF circuit according to another embodiment by way of example;

FIG. 7 is a diagram illustrating a PUF circuit according to another embodiment;

FIG. 8 is a diagram illustrating a ratio of P state/AP state according to a voltage of a digit line, as an example;

FIG. 9 is a flowchart illustrating the operation of a PUF circuit according to example embodiments, by way of example;

FIG. 10 is a diagram illustrating an electronic device according to example embodiments;

FIG. 11 is a diagram illustrating an integrated circuit illustrated in FIG. 10; and

FIG. 12 is a diagram illustrating an electronic device according to example embodiments.

### DETAILED DESCRIPTION

Hereinafter, example embodiments will be described clearly and in detail with reference to the accompanying drawings.

In the era of the Internet of Things (IoT), many electronic devices are providing convenience to human life. The importance of security technologies for safely using these electronic devices is also increasing. Hardware-based security technologies, such as Physical Unclonable Function (PUF), are gaining attention due to the vulnerabilities of software-based security solutions to hacking and other threats. PUF utilizes microscopic structural differences occurring in semiconductor manufacturing processes to generate security keys (e.g., SRAM-PUF) and is referred to as “semiconductor chip fingerprint” due to its uniqueness akin to human fingerprints. However, since the microscopic structure differences is determined during the semiconductor manufacturing process, conventional PUFs cannot be reconfigured. Therefore, the conventional PUFs may pose security risks over prolonged usage.

If PUF may generate security keys in a non-deterministic method, the security keys may be reconfigured, and security over prolonged usage may be improved. The non-deterministic method may refer to a method in which a different result is obtained each time even if the same input is given.

In example embodiments, MRAM (Magnetic Random Access Memory) may be used in PUF so that the PUF may generate security keys in a non-deterministic method.

MRAM is a memory that writes data by changing a magnetization direction of a magnetic layer included in a memory cell and measures a resistance of the memory cell to read data. MRAM is a nonvolatile memory capable of maintaining data even after power is turned off.

A memory cell of MRAM may have MTJ (magnetic tunnel junction) including two ferromagnetic layers separated by an insulating layer. The memory cell has two or more energy states representing data. For example, to represent data of one bit, a P (Parallel) state in which magnetization directions between the two ferromagnetic layers are parallel, and an AP (Anti-Parallel) state in which the magnetization directions between the two ferromagnetic layers are opposite to each other may be used.

There may be an energy barrier between the P state and the AP state. When a free energy of a free layer among the two ferromagnetic layers is reduced from a state exceeding the energy barrier to a state below the energy barrier, the memory cell may be determined to be the P state or the AP state. The state of the memory cell may be determined differently each time.

The PUF may generate a random number by controlling memory cells to have random number by using a non-deterministic characteristic of the MRAM. The generated random number may be stored in the memory cells and used to generate a security key. In order to change the security key, the PUF may reconfigure the random number stored in the memory cells by using the non-deterministic characteristic.

However, to generate pure random numbers, Magnetic Tunnel Junction (MTJ) must possess two states with very similar energy barriers.

To utilize MRAM as PUF (Physical Unclonable Function) or RNG (Random number generator), maximizing stochastic and non-deterministic switching behavior is essential. This necessitates that after overcoming MTJ energy barriers, the energies of the two states (up, down) should be identical. STT-MRAM (Spin-Transfer Torque Magnetoresistive Random Access Memory) requires alignment (reset) in one direction during switching between the P (Parallel) and AP (Anti-Parallel) states.

SOT-MRAM adjusts the magnetization direction of the free layer perpendicular to in-plane through in-plane spin current generated in the heavy metal layer, and switches the magnetic direction of the free layer to the P state or the AP state. To achieve random switching characteristics in which the P state and the AP state are each switched at a 50% probability, the energies of P state and the AP state of the free layer may be equal.

VCMA-MRAM (Voltage-Controlled Magnetic Anisotropy Magnetoresistive Random Access Memory) applies voltage to the MTJ to lower the energy barrier, then determines the P and AP states in the voltage-off situation. However, the influence of stray fields caused by the fixed layer of MTJ makes it difficult to achieve a 50% probability of switching between the P and AP states for VCMA-MRAM.

In an embodiment, PUF circuits and their operating methods may minimize/remove/reduce stray fields caused by the fixed layer by applying voltage to adjacent wordlines or adding digit lines to generate an internal magnetic field in SOT-MRAM.

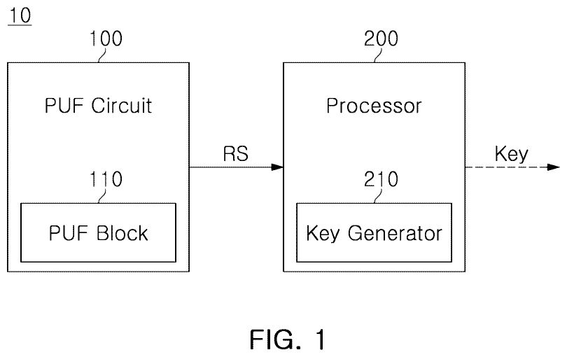

FIG. 1 is a diagram illustrating a security device 10 according to example embodiments, by way of example. Referring to FIG. 1, the security device 10 may generate a unique key KEY for security and perform security operations such as encryption/decryption and the like using the generated key KEY. The security device 10 may include a PUF circuit 100 and a processor 200.

The security device 10 may operate in either a registration mode or a use mode. In the registration mode, the security device 10 may select a valid random signal among a plurality of random signals RS generated from the PUF circuit 100 and register a key generated using the selected random signal. In the use mode, the security device 10 may generate a key using a random signal generated from the PUF circuit 100 due to a request from the host and output the generated key to the host. In example embodiments, the registration mode is performed once at the time of manufacturing the security device 10, and the use mode may be performed at multiple times when the key is to be generated using the security device 10.

In example embodiments, the PUF circuit 100 may include at least one PUF block 110. The PUF block 110 may generate a plurality of random signals RS. To this end, the PUF block 110 may include a plurality of PUF cells disposed between wordlines and bitlines. Each of the PUF cells may generate a signal of a unique value according to a physical unclonable function (PUF). In example embodiments, a PUF cell included in the PUF block 110 may have an arbitrary structure that generates a bit signal of a unique value. For example, a PUF cell may be implemented as a reconfigurable MRAM cell.

The PUF block 110 may generate a plurality of random signals RS based on signals generated by a plurality of PUF cells. Accordingly, the plurality of random signals RS may be different from random signals generated by a PUF block included in another security device of the same structure. In example embodiments, the PUF block 110 may generate an n-bit random signal RS (where n is an integer greater than 1). For example, the PUF block 110 may include n PUF cells, and one PUF cell may generate a random signal RS corresponding to 1-bit.

The processor 200 may include a key generator 210. The key generator 210 may receive a plurality of random signals RS and generate a key KEY through post-processing of the plurality of random signals RS. The key KEY is an encryption key uniquely generated by the security device 10 for security purposes, and since the integrity of the key is guaranteed, it may be used as a key for encryption and decryption or as an authentication code. The key generator 210 may determine the validity of a plurality of random signals RS and generate a row key using only valid random signals. Additionally, the processor 200 may generate a key KEY through an error correction operation for the low key.

In example embodiments, the processor 200 may generate a validity map containing information about valid random signals in a registration mode for registering a key, and store the generated validity map. In example embodiments, the processor 200 may store parity bits generated according to an error correction operation as helper data in registration mode. The key generator 210 may generate a key using the stored validity map and/or helper data in a generation mode that generates a key according to a user's request, or the like, and thus the key generation process may be performed efficiently.

Also, in FIG. 1, the PUF circuit 100 and the processor 200 are illustrated as separate configurations. However, it should be understood that embodiments are not limited thereto. The PUF circuit 100 and processor 200 of embodiments may be implemented as one configuration. In example embodiments, the PUF circuit 100 is implemented with a hardware configuration including a PUF block 110, and the processor 200 may be implemented in software, hardware, or firmware performed by a controller that controls the PUF block 110.

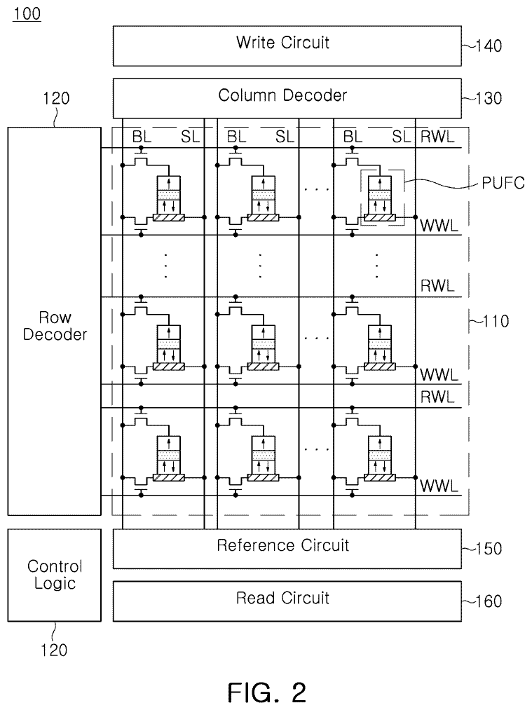

FIG. 2 is a diagram illustrating a PUF circuit 100 according to example embodiments. Referring to FIG. 2, the PUF circuit 100 may include a cell array 110, a row decoder 120, a column decoder 130, a write circuit 140, a reference cell circuit 150, a read circuit 160, and control logic 170.

The cell array 110 may include a plurality of variable resistance cells PUFC connected between a read wordline RWL, a write wordline WWL, a bitline BL, and a source line SL.

The variable resistance cell PUFC may include a material layer whose resistance value changes. The variable resistance cell PUFC may have resistance values corresponding to data “0” and “1.” For example, a variable resistance cell PUFC may store data “0” by having a resistance value lower than a predetermined reference resistance value. Conversely, the variable resistance cell PUFC may store data “1” by having a resistance value higher than a predetermined reference resistance value. In this case, the data “0” and “1” according to the resistance value are illustrative and may be reversed. In example embodiments, the variable resistance cell PUFC may include a magnetic material. A variable resistance cell PUFC may include a magnetic tunnel junction (MTJ) structure. The variable resistance cell PUFC is in contact with the spin orbit torque layer (SOT layer) HM. The variable resistance cell PUFC is formed on the SOT layer.

The row decoder 120 may be implemented to select a read wordline RWL in response to a read address during a read operation, or to select a write wordline WWL in response to a write address during a write operation. The column decoder 130 may be implemented to select the bitline BL and source line SL in response to an address (read address/write address). The write circuit 140 may be implemented to apply a current/voltage corresponding to write data to a corresponding variable resistance cell PUFC during a write operation. The reference cell circuit 150 may include reference cells for comparing data of a target variable resistance cell PUFC in a read operation or write operation. The read circuit 160 may be implemented to determine data by comparing the current/voltage read from the variable resistance cell PUFC with that of the reference cell during a read operation. The control logic 170 may be implemented to control the row decoder 120, column decoder 130, write circuit 140, reference cell circuit 150, and read circuit 160 during a read or write operation.

The PUF circuit 100 according to example embodiments may perform a memory function by changing the magnetization direction of the magnetic material constituting the variable resistance cell PUFC using the SOT phenomenon. Specifically, the PUF circuit 110 may generate a random number using a non-deterministic characteristic of the PUFC and store the random number in the variable resistance cell PUFC. The variable resistance cell PUFC may include a SOT-type MTJ. The PUF circuit 100 according to example embodiments may be a SOT-type MRAM device or a SOT-type magnetoresistive memory device. For example, SOT-type magnetoresistive memory devices may have high-speed switching, high endurance, and low read confusion characteristics.

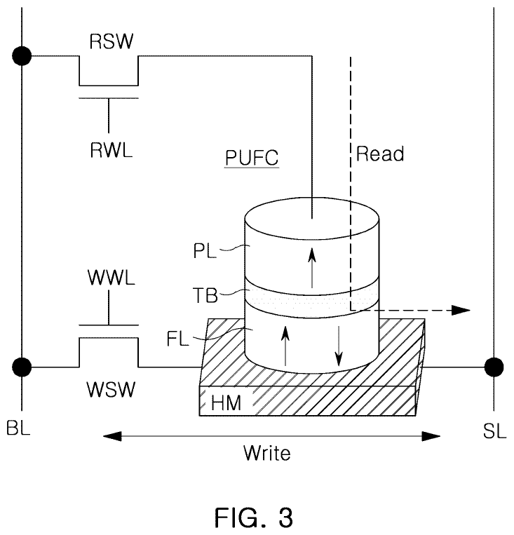

FIG. 3 is a diagram illustrating a variable resistance cell PUFC according to example embodiments. Referring to FIG. 3, the variable resistance cell PUFC may include a Free Layer FL formed on top of the SOT layer (Heavy Metal, HM), a Tunnel Barrier TB formed on top of the free layer FL, and a Pinned layer PL formed on TB.

The SOT layer HM may be connected to the source line SL. The SOT layer HM may be connected to the bitline BL by switching the transistor WSW according to the voltage of the write wordline WWL during a write operation. In example embodiments, the SOT layer HM may be a heavy metal layer. For example, the SOT layer HM may be a tungsten layer, a cobalt layer, a tantalum layer, or a platinum layer.

The free layer FL may be formed on top of the SOT layer HM. The free layer FL may be an ordered alloy and may include at least one of iron (Fe), cobalt (Co), nickel (Ni), palladium (Pa), and platinum (Pt). The free layer FL may include at least one of Fe—Pt alloy, Fe—Pd alloy, Co—Pd alloy, Co—Pt alloy, Fe—Ni—Pt alloy, Co—Fe—Pt alloy, and Co—Ni—Pt alloy. For example, these alloys may be chemical-quantitatively expressed as Fe₅₀Pt₅₀, Fe₅₀Pd₅₀, Co₅₀Pd₅₀, Co₅₀Pt₅₀, Fe₃₀Ni₂₀Pt₅₀, Co₃₀Fe₂₀Pt₅₀, or Co₃₀Ni₂₀Pt₅₀.

The magnetization direction of the free layer FL may be variable depending on environmental conditions such as voltage/current flowing in the SOT layer HM. In example embodiments, the free layer FL has a magnetization direction perpendicular to the film surface forming the free layer FL. In another embodiment, the free layer FL has a magnetization direction horizontal to the film surface forming the free layer FL.

Generally, when the magnetization direction in the free layer FL and the magnetization direction in the pinned layer PL are parallel, the variable resistance cell PUFC has a low resistance value. This low resistance value may correspond to data “0.” In detail, when the magnetization direction of the free layer FL and the magnetization direction of the pinned layer PL are parallel P, the variable resistance cell PUFC has a low resistance value, and may indicate data “0.” Also, when the magnetization direction of the free layer FL and the magnetization direction of the pinned layer PL are antiparallel AP, the variable resistance cell PUFC has a high resistance value. This high resistance value may correspond to data “1.” In detail, when the magnetization direction of the free layer FL and the magnetization direction of the pinned layer PL are antiparallel, the variable resistance cell PUFC has a high resistance value, and may indicate data “1.”

A tunnel barrier TB may be formed on top of the free layer FL. The tunnel barrier TB may have a thickness thinner than the spin diffusion distance. The tunnel barrier TB may include a non-magnetic material. In example embodiments, the tunnel barrier TB may contain at least one selected from oxides of magnesium (Mg), titanium (Ti), aluminum (Al), magnesium-zinc (MgZn) and magnesium-boron (MgB), and nitrides of titanium (Ti) and vanadium V.

The pinned layer PL may be formed on top of the tunnel barrier TB. The pinned layer PL may be connected to the bitline BL by switching the transistor RSW according to the voltage of the read wordline RWL during a read operation. In example embodiments, the ferromagnetic material forming the pinned layer PL may include at least one of Co, Fe, and Ni. In addition, the pinned layer PL may further include other elements such as B, Cr, Pt, Pd, or the like. The pinned layer PL is illustrated as a single layer, but is not limited thereto and may have a multi-layer structure. In example embodiments, the pinned layer PL has a multilayer structure in which a first layer formed of at least one of Co and a Co alloy and a second layer formed of at least one of Pt, Ni, and Pd are alternately stacked, or may be an FePt layer or a CoPt layer having an L10 structure, or may be an alloy layer of a rare-earth element and a transition metal. In this case, the rare earth element may be at least one of Tb and Gd, and the transition metal may be at least one of Ni, Fe, and Co. Various combinations of alloys of rare earth elements and transition metals may be used, and among them, for example, CoFeB or CoFe may be used as a material for the pinned layer PL. The pinned layer PL may be an ordered alloy and may include at least one of iron (Fe), cobalt (Co), nickel (Ni), palladium (Pa), and platinum (Pt). For example, the pinned layer PL may include at least one of Fe—Pt alloy, Fe—Pd alloy, Co—Pd alloy, Co—Pt alloy, Fe—Ni—Pt alloy, Co—Fe—Pt alloy, and Co—Ni—Pt alloy. The alloys may, for example, in chemical quantitative terms, be Fe₅₀Pt₅₀, Fe₅₀Pd₅₀, Co₅₀Pd₅₀, Co₅₀Pt₅₀, Fe₃₀Ni₂₀Pt₅₀, Co₃₀Fe₂₀Pt₅₀, or Co₃₀Ni₂₀Pt₅₀.

In example embodiments, the magnetization direction of the pinned layer PL is fixed. In example embodiments, the pinned layer PL has a magnetization direction perpendicular to the film surface forming the pinned layer PL. In another embodiment, the pinned layer PL has a magnetization direction horizontal to the film surface forming the pinned layer PL.

Also, in the variable resistance cell PUFC, the positions of the free layer FL and the pinned layer PL may be implemented to be opposite to each other. For example, the variable resistance cell may form a pinned layer PL on top of the SOT layer HM, a tunnel barrier TB on top of the PL, and a free layer (PL) on top of the TB.

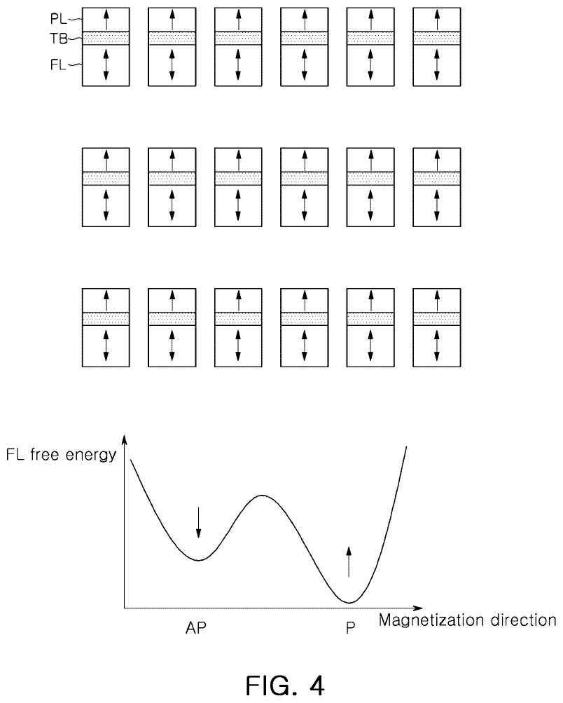

FIG. 4 is a diagram explaining the existence of a stray field in a general PUF circuit. Generally, the pinned layer PL is part of the MRAM cell, and the spin direction thereof is fixed. This pinned layer PL may form a magnetic field, referred to a stray field. These stray fields may affect free energy level of the free layer FL at the P state and the AP state. In an example of FIG. 4, an energy level at the P state may be lower than an energy level at the AP state. The difference of energy levels at the P state and the AP state occurs difficult to generate a pure random number using the MRAM cells.

Specifically, when a write voltage is applied to a SOT line connected to the MRAM cells, free energy of the free layers FL of the MRAM cells may overcome an energy barrier. For example, a magnetization direction of the free layers FL may be perpendicular to the magnetization direction of the fixed layer PL. When the write voltage applied to the SOT line is removed, each of the free layers FL may transit to the P state or the AP state. When the energy level of the P state is lower than the energy level of the AP state, a possibility that each of the free layers FL transits to the P state may be higher than a possibility that each of the free layer FL transits to the AP state. That is, the MRAM cells cannot generate a pure random number.

The PUF circuit according to example embodiments may eliminate or minimize the stray field caused by the pinned layer PL by generating an internal magnetic field in various manners.

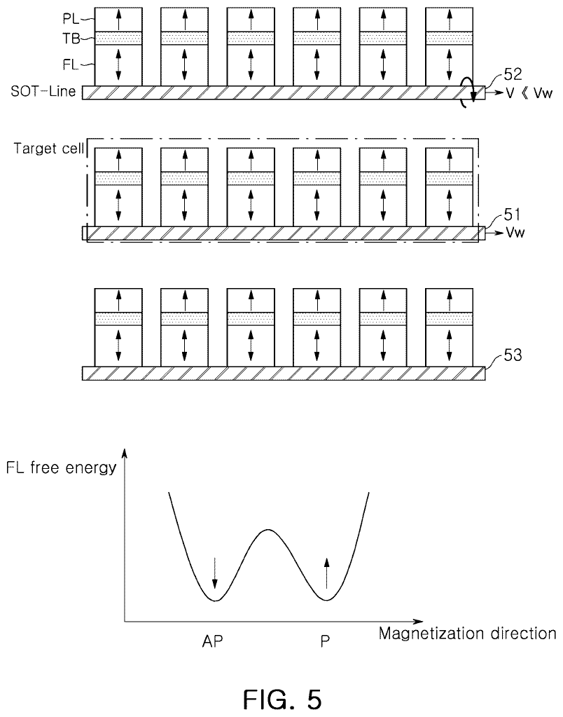

FIG. 5 is a diagram exemplarily illustrating stray field removal by generating an internal magnetic field in a PUF circuit according to example embodiments. Referring to FIG. 5, stray fields may be removed or minimized by applying a voltage V to the SOT line 52 adjacent to target cells where a random number will be stored. For example, a magnetic force may be generated upward due to a magnetization direction of the pinned layers PL of the target cells. An upward direction may refer to a direction from the free layer FL toward the pinned layer PL. When the voltage V applied to the SOT line 52, a current may flow through the SOT line 52. A direction of the current may be determined to generate a magnetic force in a downward direction at the target cells.

When the influence of the stray field is removed or minimized, the energy levels of the P state and the AP state may be equal. The PUF circuit may apply a write voltage Vw to the SOT line 51 connected to the target cells, while the voltage V is applied to the SOT line 52. No voltage may be applied to bit lines connected to the target cells. When the write voltage Vw is applied to the SOT line 51, free energy of the free layers FL of the target cells may overcome an energy barrier. When the write voltage Vw applied to the SOT line 51 is removed, each of the target cells may have the P state or the AP state with a probability of 50%. That is, the PUF circuit may generate a pure random number in the target cells by removing or minimizing the influence of the stray field.

In this case, the voltage Vis smaller than the write voltage Vw. SOT lines 51, 52, and 53 include the heavy metal HM of FIG. 3.

Also, in FIG. 5, voltage is applied to the SOT line 52 corresponding to the variable resistance cell located above the target cell to remove or reduce the stray field. SOT line 52 is adjacent to the target cell, and may be referred to as a second SOT line (in comparison to the SOT line 51 of the target cell). However, embodiments are not limited thereto. Also, to remove or reduce the stray field, voltage may be applied to the SOT line 53 corresponding to the variable resistance cell located below the target cell. Thus, SOT line 53 is adjacent to the target cell, and may also be referred to as a second SOT line.

In example embodiments, the PUF circuit may generate an internal magnetic field by sequentially applying a wordline voltage to a plurality of variable resistance cells in a scan manner.

Also, the PUF circuit according to example embodiments may add a separate digit line to remove stray fields.

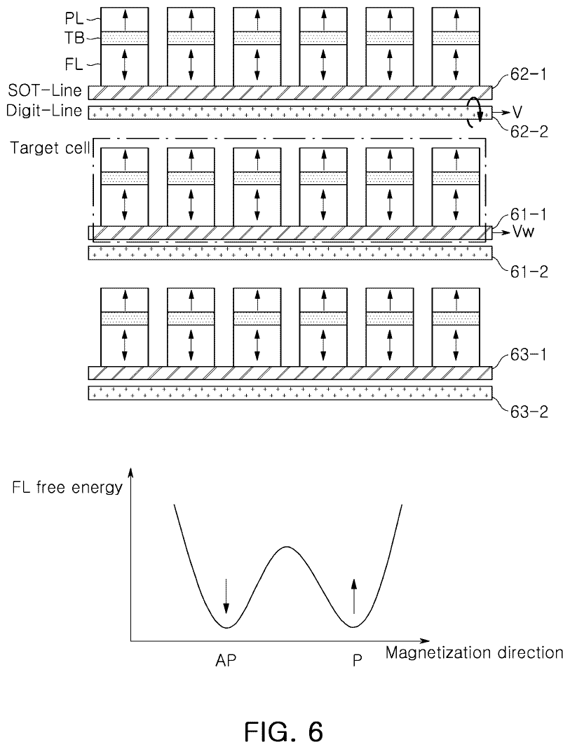

FIG. 6 is a diagram illustrating the removal of stray fields by generating a magnetic field in a PUF circuit according to another embodiment. Referring to FIG. 6, in each of the variable resistance cells, corresponding digit lines 61-2, 62-2, and 63-2 may be disposed below the SOT lines 61-1, 62-1, and 63-1. The digit lines 61-2, 62-2, and 63-2 may form a magnetic field when a current flows to the digit lines 61-2, 62-2, and 63-2. In example embodiments, to remove stray fields, a voltage V may be applied to the digit line 62-2 corresponding to a cell adjacent to the target cell. A write voltage Vw may be applied to the SOT line 61-1 corresponding to the target cell. After the write voltage Vw is applied to the SOT line 61-1 connected to the target cells, each of the target cells may have the P state or the AP state with a probability of 50%, and a pure random number may be stored in the target cells.

Also, the position of the digit line may be configured in various manners. For example, digit lines may be placed below the MTJ, above the MTJ, and to the left/right of the MTJ. Also, in the case of SOT-MRAM, write disturbance due to SOT-line sharing may be reduced. In example embodiments, the digit line may be operated to remove stray fields only for specific wordlines. In another embodiment, the digit line may apply an operation to remove stray fields, to the entire cell array.

FIG. 7 is a diagram illustrating a PUF circuit 300 according to another embodiment, by way of example. Referring to FIG. 7, the PUF circuit 300 may include a resistance cell RVC, a SOT line 311, a digit line 312, a first transistor T1, and a second transistor T2.

The resistance cell RVC may be connected between the bitline BL and the SOT line 311. The resistance cell RVC may include a free layer FL, a tunnel barrier TB, and a pinned layer PL. The free layer FL may be formed on the SOT line 311. A tunnel barrier TB may be formed on top of the free layer FL. The pinned layer PL may be formed on the tunnel barrier TB. The bitline BL may be formed on the pinned layer PL. The first transistor T1 may connect the wordline WL to the SOT line 311 in response to the first switch signal SW1. In this case, the SOT line 311 may be connected to the source line SL. The second transistor T2 may provide the digit voltage VDL to the digit line 312 in response to the second switch signal SW2.

To remove the stray field caused by the pinned layer remaining in the MTJ, the digit line used in MRAM is added to generate an internal magnetic field, thereby significantly reducing the stray field in the free layer, caused by the pinned layer.

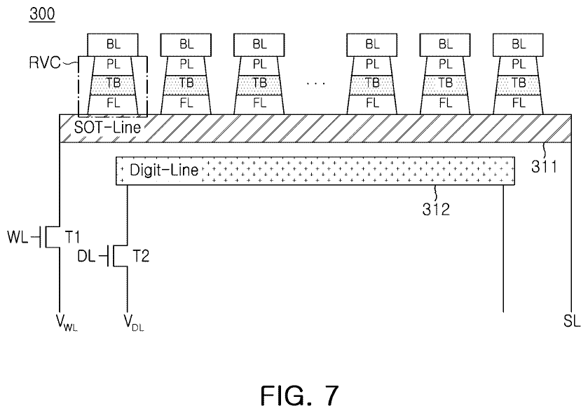

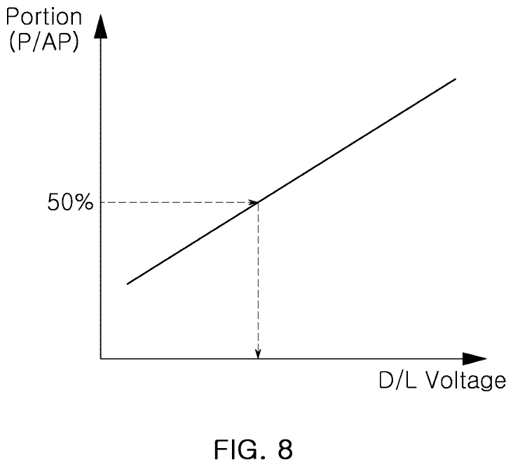

FIG. 8 is a diagram illustrating the ratio of P state/AP state according to the voltage of the digit line. Referring to FIG. 8, the magnitude of the internal magnetic field generated by the digit line D/L may be different, and the ratio of P state/AP state may be different. In example embodiments, the voltage of digit line D/L may be experimentally determined. The voltage of the digit line D/L may be selected as a voltage in which probabilities of the P state and the AP state are 50%, respectively.

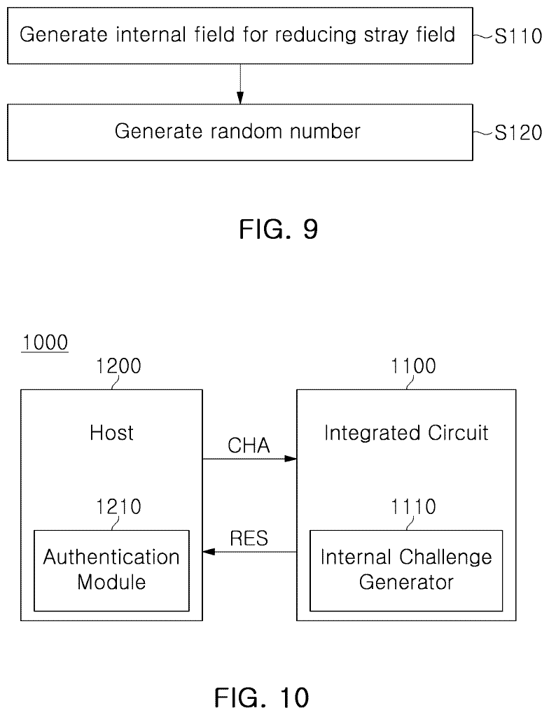

FIG. 9 is a flowchart exemplarily illustrating the operation of a PUF circuit according to example embodiments. Referring to FIGS. 1 to 9, the PUF circuit may generate random numbers as follows. The PUF circuit may generate an internal magnetic field to reduce the stray field of the MRAM (S110). The PUF circuit may control each of memory cells to have a random state of the P state or the AP state by applying a write voltage to the memory cells included in the MRAM, in a state in which the stray field is reduced. That is, a random number may be generated in the memory cells. (S120).

The PUF circuit may perform a read operation on the memory cells and output the random number stored in the memory cells. The random number may be used to generate a security key.

In example embodiments, the PUF circuit may reconfigure the random number stored in the memory cells by performing operations S110 and S120 again, even after the random number is stored in the memory cells. Accordingly, the security of the security device including the PUF circuit may be improved.

In example embodiments, the MRAM may be Spin-Orbit Torque Magnetic Random-Access Memory (SOT-MRAM). In example embodiments, the MRAM includes a plurality of variable resistance cells, and each of the plurality of variable resistance cells includes a SOT line connected to a corresponding source line and providing a wordline voltage according to the voltage of the corresponding wordline; a pinned layer formed on the SOT line and having a fixed spin direction; a tunnel barrier formed on top of the pinned layer; and a free layer formed on top of the tunnel barrier. The target cell may be any one of the plurality of variable resistance cells.

In example embodiments, a predetermined voltage may be applied to an adjacent SOT line corresponding to a variable resistance cell adjacent to the target cell among a plurality of variable resistance cells, and, a write voltage may be applied to a target SOT line corresponding to the target cell. The predetermined voltage is less than the write voltage. In example embodiments, each of the plurality of variable resistance cells may further include a digit line below the SOT line. In example embodiments, a voltage may be applied to an adjacent digit line corresponding to a variable resistance cell adjacent to the target cell among the plurality of variable resistance cells, and a write voltage may be applied to the target SOT line corresponding to the target cell.

In another embodiment, the MRAM includes a plurality of variable resistance cells, and each of the plurality of variable resistance cells includes a digit line; a SOT line formed above the digit line, connected to a corresponding source line, and providing a wordline voltage according to the voltage of the corresponding wordline; a free layer formed on top of the SOT line; a tunnel barrier formed on top of the free layer; and a pinned layer formed on top of the tunnel barrier, connected to a corresponding bitline, and having a fixed spin direction. The target cell may be any one of the plurality of variable resistance cells. In example embodiments, a voltage may be applied to an adjacent digit line corresponding to a variable resistance cell adjacent to the target cell among the plurality of variable resistance cells, and a write voltage may be applied to a target SOT line corresponding to the target cell.

FIG. 10 is a diagram illustrating an electronic device 1000 according to example embodiments. Referring to FIG. 10, the electronic device 1000 may include an integrated circuit 1100 and a host device 1200.

The integrated circuit 1100 may be referred to as an integrated circuit or device for challenge-response authentication. The integrated circuit 1100 may be implemented to generate a response RES corresponding to the challenge CHA. The integrated circuit 1100 may be manufactured through a semiconductor process, and the components of the integrated circuit 1100 may be packaged in a single package or may be individually packaged in two or more packages.

The integrated circuit 1100 may include an internal challenge generator 1110. The internal challenge generator 1110 may generate an internal challenge in response to the challenge CHA. In example embodiments, the internal challenge generator 1110 may generate an internal challenge based on a non-linear function. In example embodiments, the internal challenge generator 1110 may generate an internal challenge by applying a challenge CHA to a hash function (for example, CRC32(Cyclical Redundancy Check 32), md5 (message digest algorithm 5), SHA-1(Secure Hash Algorithm-1), SHA-256(Secure Hash Algorithm-256), RIPEMD-128(Race Integrity Primitives Evaluation Message Digest-128), Tiger). In example embodiments, the internal challenge generator 1110 may generate an internal challenge by applying the challenge CHA to a predetermined encryption algorithm (for example, Data Encryption Standard (DES), Triple DES, Advanced Encryption Standard (AES), Rivest Shamir Adleman (RSA), and Elliptic Curve Cryptosystem (ECC)). In example embodiments, the internal challenge generator 1110 may generate an internal challenge by scrambling data by applying a challenge CHA to a scramble function. In example embodiments, the internal challenge generator 1110 may select a valid internal challenge among generated internal challenges in authentication mode.

The integrated circuit 1100 may select a valid internal challenge among a plurality of generated internal challenges and generate a response RES using only the valid internal challenge. In example embodiments, in the registration mode, the integrated circuit 1100 may determine a valid first internal challenge among a plurality of first internal challenges generated in response to each of a plurality of challenges, and store information about the valid first internal challenge. In the authentication mode, the integrated circuit 1100 selects a valid internal challenge among a plurality of internal challenges generated in response to the challenge CHA based on information about the first valid internal challenge, and may generate response RES using only valid internal challenges.

Additionally, the integrated circuit 1100 may generate random numbers through the PUF circuit described in FIGS. 1 to 9 and generate response RES using the generated random numbers.

The host device 1200 may include an authentication module 1210. The host device 1200 is a network system operated by an entity with authenticated rights to the integrated circuit 1100, and may be, for example, a network system of a manufacturer of the integrated circuit 1100. The host device 1200 may be implemented in the form of a server, and the integrated circuit 1100 may be connected to the host device 1200 using a wired or wireless network.

In registration mode, the authentication module 1210 may register the integrated circuit 1100. In example embodiments, the authentication module 1210 outputs a plurality of challenges to the integrated circuit 1100, and the authentication module 1210 may store a plurality of challenges and challenge-response pairs, which are corresponding pairs of a plurality of responses received in response to each of the plurality of challenges. The authentication module 1210 may perform a registration operation according to the registration mode once during the lifecycle of the integrated circuit 1100. In example embodiments, the registration operation may be performed immediately after the integrated circuit 1100 is manufactured. In example embodiments, the number of challenge-response pairs may be arbitrarily determined by the host device 1200, as the number or more that may be used to perform an authentication operation to authenticate the integrated circuit 1100 during the life cycle of the integrated circuit 1100.

In the authentication mode, the authentication module 1210 may perform authentication on the integrated circuit 1100. In example embodiments, the authentication module 1210 randomly determines one challenge CHA among a plurality of challenges included in challenge-response pairs generated in registration mode, and the authentication module 1210 may output the determined challenge CHA to the integrated circuit 1100. Additionally, the authentication module 1210 may authenticate the integrated circuit 1100 based on the response RES received from the integrated circuit 1100 in response to the challenge CHA. In example embodiments, the authentication module 1210 may authenticate the integrated circuit 1100 based on whether the received response RES is the same as the response corresponding to the challenge CHA.

Also, the first internal challenge may refer to an internal challenge occurring in registration mode, and the first internal response may refer to an internal response occurring in registration mode.

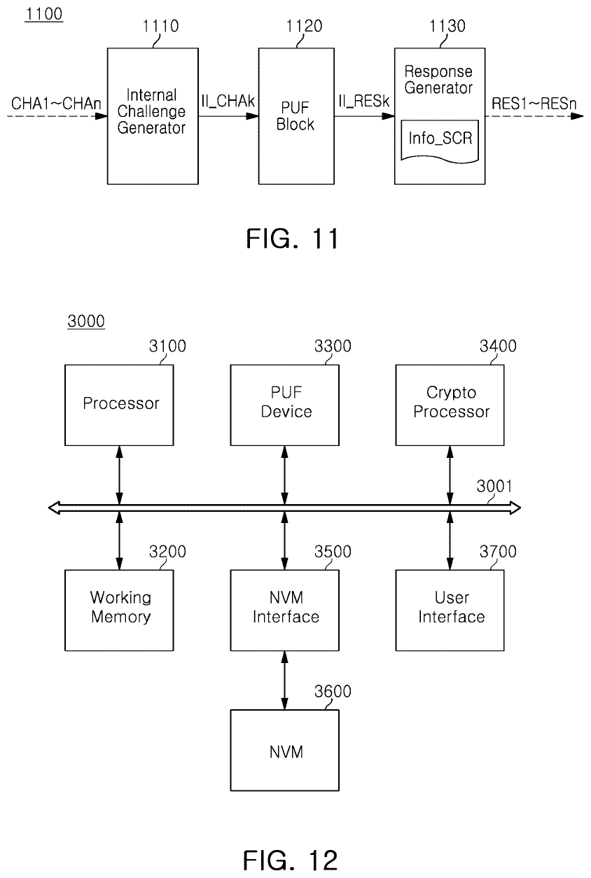

FIG. 11 is a diagram illustrating the integrated circuit 1100 illustrated in FIG. 10. Referring to FIG. 11, the integrated circuit 1100 may include an internal challenge generator 1110, a PUF block 1120, and a response generator 1130.

The internal challenge generator 1110 may perform the same or similar operations as those in registration mode. In the registration mode, the internal challenge generator 1110 may receive a plurality of challenges CHA1 to CHAn from the outside (for example, the host device 1200 of FIG. 10). A plurality of challenges CHA1 to CHAn may be a challenge set that may be used as a challenge-response pair, and may be arbitrarily determined by the host device 1200. The number of challenges CHA1 to CHAn may correspond to the number of times that may be authenticated during the life cycle of the integrated circuit 1100 and may be arbitrarily determined by the host device 1200.

The internal challenge generator 1110 may sequentially generate a plurality of initial internal challenges II_CHAk corresponding to each of the plurality of challenges CHA1 to CHAn using a conversion algorithm. In example embodiments, multiple initial internal challenges may be generated in response to one challenge. In example embodiments, the conversion algorithm may include any one of an encryption algorithm, a hash algorithm, and a scramble algorithm, as described above in FIG. 1.

The PUF block 1120 may sequentially receive a plurality of initial internal challenges II_CHAk and sequentially generate a corresponding initial internal response II_RESk. The PUF block 1120 may include a plurality of PUF source circuits. The PUF source circuit may generate a signal of a unique value according to a Physically unclonable Function (PUF), and may also be referred to as a PUF cell. In the PUF source circuit, unique values of hardware may be extracted, and the extracted values may be used in applications that require security, such as secure communication, secure data processing, user identification, firmware update, and the like. In example embodiments, the PUF source circuit may have any structure that generates a bit signal of a unique value. The PUF source circuit may be implemented as a PUF circuit with a variable resistance cell that eliminates stray fields using an internal magnetic field as described in FIGS. 1 to 9.

The PUF block 1120 may generate an initial internal response II_RESk based on signals generated by a plurality of PUF source circuits and an initial internal challenge II_CHAk, and accordingly, the initial internal response II_RESk may be different from the initial internal response that occurs from the same initial internal challenge II_CHAk in a PUF block included in another integrated circuit of the same structure. In example embodiments, the PUF block 1120 may generate an n-bit initial internal response II_RESk (where n is an integer greater than 1). For example, the PUF block 1120 may include n PUF source circuits, and one PUF source circuit may generate a bit signal corresponding to 1-bit.

The response generator 1130 may receive an initial internal response II_RESk and sequentially generate a plurality of responses RES1 to RESn from the initial internal response II_RESk. Additionally, the response generator 1130 may generate screen information Info_SCR based on the initial internal response II_RESk. In example embodiments, the response generator 1130 may generate screen information based on the Hamming weight of the initial internal response II_RESk of n (n is a natural number) bits. Hamming weight may refer to the number of symbols different from the zero symbol, for example, may refer to the number of ‘1’ in a multi-bit signal. Accordingly, the Hamming weight (HW) of the n-bit initial internal response II_RESk may have a value of 0 to n.

The initial internal response II_RESk generated by the PUF block 1120 may be different from the internal response generated in other integrated circuits, and accordingly, the Hamming weights of internal responses generated in integrated circuits may have a distribution between 0 and n. For example, while the number of integrated circuits that generate an initial internal response II_RESk with a Hamming weight of approximately n/2 is relatively large, the number of integrated circuits that generate an initial internal response II_RESk with a Hamming weight of approximately 0 or n may be relatively small.

For challenge-response authentication to succeed, it may be required that a certain response corresponding to the same challenge be generated. The response generator 1130 may prevent errors that may occur in the PUF block 110 from accumulating by generating a plurality of responses RES1 to RESn based on the Hamming weight. For example, at least some of the plurality of PUF source circuits included in the PUF block 1120 may generate bit signals of a constant value, while at least some of the others may generate bit signals that vary under conditions (for example, time, depending on temperature, voltage, or the like). The former may be referred to as a stable PUF source circuit, while the latter may be referred to as an unstable PUF source circuit. If a plurality of bit signals output from a plurality of PUF source circuits are merged through a logical operation (for example, AND, OR, or the like) to generate response, an error may occur due to unstable PUF source circuits. For example, errors in unstable PUF source circuits may accumulate in the response. However, as will be described later, the accumulation of errors due to unstable PUF source circuits may be prevented by using the Hamming weight to generate the response by the response generator 1130, and as a result, a certain response may be generated corresponding to the same challenge.

In authentication mode, the internal challenge generator 1110 may receive a first challenge CHA from the outside. The first challenge CHA may be one of the plurality of challenges CHA1 to CHAn used in the registration mode of FIG. 3. The internal challenge generator 1110 may receive screen information Info_SCR. In example embodiments, the internal challenge generator 1110 may receive screen information Info_SCR from the host. In example embodiments, the internal challenge generator 1110 may read screen information Info_SCR from a storage element included in the integrated circuit 1100.

The internal challenge generator 1110 may sequentially generate a plurality of internal challenges corresponding to the first challenge CHA using a conversion algorithm. The internal challenge generator 1110 may select a valid internal challenge VI_CHA from a plurality of internal challenges based on screen information Info_SCR generated in registration mode. In example embodiments, when the validity bit VB is stored in screen information Info_SCR, the internal challenge generator 1110 may select the internal challenge corresponding to the first internal response having the first value (‘O’) as the validity bit VB as the effective internal challenge VI_CHA. In example embodiments, when the valid count CNT_V is stored in screen information Info_SCR, the internal challenge generator 1110 selects a valid first internal response by counting the first internal response with a first value (‘O’) as the validity bit VB based on the validity count CNT_V, and may select the internal challenge corresponding to the first valid internal response as the effective internal challenge VI_CHA. In example embodiments, when the invalid count CNT_IV is stored in screen information Info_SCR, the internal challenge generator 1110 may select an invalid initial internal response by counting the initial internal response with a second value (‘X’) as the validity bit VB based on the invalid count CNT_IV, and may select the internal challenge corresponding to the selected valid internal response as the valid internal challenge VI_CHA by excluding the invalid initial internal response.

The PUF block 1120 may receive a valid internal challenge VI_CHA and sequentially generate a valid internal response VI_RES corresponding thereto. Since filtering of invalid internal responses has been performed using screen information Info_SCR, valid internal responses VI_RES may be valid data with a value of ‘1’ or ‘0’ based on the Hamming weight.

The response generator 1130 may receive a valid internal response VI_RES and generate a first response RES by accumulating or concatenating the valid internal response VI_RES. In example embodiments, the first response RES may be the same as the response generated in response to the first challenge CHA in registration mode. In example embodiments, the response generator 1130 may generate the first response RES based on the Hamming weight of the effective internal response VI_RES.

In the electronic device 1000 according to example embodiments, the internal challenge generator 1110 may select a valid internal challenge VI_CHA from a plurality of internal challenges using screen information Info_SCR generated during the registration process. Additionally, the integrated circuit 1100 may prevent an invalid internal challenge from being unnecessarily applied to the PUF block 1120 by generating the first response RES using only the valid internal challenge VI_CHA.

FIG. 12 is a diagram illustrating an electronic device 3000 according to example embodiments. Referring to FIG. 12, the electronic device 3000 may include a processor 3100, a working memory 3200, a PUF device 3300, a cryptographic processor 3400, a NVM interface 3500, a NVM 3600, and a user interface 3700 connected to a bus 3001.

The processor 3100 may control the overall operation of the electronic device 3000. The processor 3100 is a central processing unit and may perform various types of operations. For example, the processor 3100 may include at least one or more processor cores.

The working memory 3200 may exchange data with the processor 3100. The working memory 3200 may temporarily store data used in the operation of the electronic device 3000. For example, the working memory 3200 may include high-speed memory such as dynamic random access memory (DRAM), SRAM, and the like.

The PUF device 3300 may be implemented as a PUF circuit as described in FIGS. 1 to 9. The PUF device 3300 may generate keys necessary for security. PUF device 3300 may be implemented in hardware, software, or firmware. The encryption processor 3400 may perform encryption and decryption operations using the key output from the PUF device 3300.

The NVM interface 3500 may exchange data with the NVM 3600 under the control of the processor 3100, the PUF device 3300, or the encryption processor 3400. The NVM (3600) may store data that needs to be preserved regardless of power supply. In example embodiments, marking data, first mask data, and second mask data may be stored in the NVM 3600, and the PUF device 3300 may not include an NVM therein.

The user interface 3700 may relay communication between the user and the electronic device 3000 under the control of the processor 3100. As an example embodiment, the user interface 3700 may include an input interface such as a keyboard, keypad, buttons, touch panel, touch screen, touch pad, touch ball, camera, microphone, gyroscope sensor, and vibration sensor. Furthermore, the user interface 3700 may include output interfaces such as a Liquid Crystal Display (LCD) device, a Light Emitting Diode (LED) display device, an Organic LED (OLED) display device, an Active Matrix OLED (AMOLED) display device, a speaker, and a motor.

The bus 3800 may provide a communication path between components of electronic device 3000. Components of the electronic device 3000 may exchange data with each other according to the bus format. As an example, the bus format may include a universal serial bus (USB), a small computer system interface (SCSI), a peripheral component interconnect express (PCIe), an advanced technology attachment (ATA), a parallel ATA (PATA), a serial ATA (SATA), a serial attached SCSI (SAS), integrated drive electronics (IDE), and the like.

The device described above may be implemented with hardware components, software components, and/or a combination of hardware components and software components. For example, the devices and components described in the example embodiments may be implemented using one or more general-purpose or special-purpose computers, such as a processor, a controller, an arithmetic logic unit (ALU), a digital signal processor, a microcomputer, a field programmable gate array (FPGA), a programmable logic unit (PLU), a microprocessor, or any other device capable of executing and responding to instructions. The processing device may execute an operating system (OS) and one or more software applications running on the operating system. Additionally, a processing device may access, store, manipulate, process, and generate data in response to the execution of software. For ease of understanding, the processing unit may be described as being used in some cases, but those skilled in the art will appreciate that a processing device may include a plurality of processing elements or multiple types of processing elements. For example, a processing device may include a plurality of processors or one processor and one controller. Additionally, other processing configurations, such as parallel processors, are also possible.

Software may include computer programs, code, instructions, or a combination of one or more thereof, and may configure processing units to operate as required or command processing units independently or collectively. Software and/or data may be embodied in any type of machine, component, physical device, virtual equipment, computer storage medium, or device, to be interpreted by or to provide instructions or data to a processing device. Software may be distributed over networked computer systems and stored or executed in a distributed manner. Software and data may be stored on one or more computer-readable recording media.

In embodiments, MRAM random number generation characteristics may be improved using internal magnetic field generation and may be applied to PUF.

As set forth above, in a physical unclonable function circuit, a security circuit having the same, and a method of operating the same according to example embodiments, good quality random numbers may be generated by removing stray fields using an internal magnetic field.

A physical unclonable function circuit, a security circuit having the same, and a method of operating the same according to example embodiments may generate reconfigurable random numbers.

While example embodiments have been illustrated and described above, it will be apparent to those skilled in the art that modifications and variations could be made without departing from the scope of the appended claims.

1. A method of operating a physical unclonable function circuit using Magnetoresistive Random Access Memory (MRAM), comprising:
generating an internal magnetic field to reduce a stray field of target cells; and
generating a random number in the target cells by controlling a voltage applied to the target cells.

2. The method of claim 1, wherein the MRAM is a Spin-Orbit Torque Magnetoresistive Random-Access Memory (SOT-MRAM).

3. The method of claim 1, wherein the MRAM includes a plurality of variable resistance cells,
wherein each of the plurality of variable resistance cells comprises:
a SOT line connected to a corresponding source line, wherein the SOT line is configured to be provided with a wordline voltage;
a free layer formed on top of the SOT line;
a tunnel barrier formed on top of the free layer; and
a pinned layer formed on top of the tunnel barrier and having a fixed spin direction, and
wherein the target cells are some of the plurality of variable resistance cells.

4. The method of claim 3, wherein the generating of the internal magnetic field includes applying a predetermined voltage to an adjacent SOT line, wherein the adjacent SOT line corresponds to a variable resistance cell adjacent to the target cells among the plurality of variable resistance cells.

5. The method of claim 4, wherein the generating a random number in the target cells generating of the internal magnetic field further comprises applying a write voltage to a target SOT line, wherein the target SOT line corresponds to the target cells, and
wherein the predetermined voltage is lower than the write voltage.

6. The method of claim 3, wherein each of the plurality of variable resistance cells further comprises a digit line below the SOT line.

7. The method of claim 6, wherein the generating of the internal magnetic field comprises applying a voltage to the digit line, wherein the digit line corresponds to a variable resistance cell adjacent to the target cells among the plurality of variable resistance cells.

8. The method of claim 7, wherein the generating a random number in the target cells further comprises applying a write voltage to a target SOT line, wherein the target SOT line corresponds to the target cells.

9. The method of claim 1, wherein the MRAM comprises a plurality of variable resistance cells,
wherein each of the plurality of variable resistance cells comprises:
a digit line;
a SOT line formed above the digit line, connected to a corresponding source line, wherein the SOT line is configured to be provided with a wordline voltage;
a free layer formed on top of the SOT line;
a tunnel barrier formed on top of the free layer; and
a pinned layer formed on top of the tunnel barrier, connected to a corresponding bitline, and having a fixed spin direction, and
wherein the target cells are some of the plurality of variable resistance cells.

10. The method of claim 9, wherein the generating of the internal magnetic field comprises applying a voltage to an adjacent digit line, wherein the adjacent digit line corresponds to a variable resistance cell adjacent to the target cells among the plurality of variable resistance cells, and
wherein the generating a random number in the target cells comprises applying a write voltage to a target SOT line, wherein the target SOT line corresponds to the target cells.

11. A physical unclonable function circuit comprising:
a plurality of variable resistance cells,
wherein each of the plurality of variable resistance cells comprises:
a Spin-Orbit Torque (SOT) line (SOT line) connected to a corresponding source line, wherein the SOT line is configured to be provided with a wordline voltage;
a free layer formed on top of the SOT line;
a tunnel barrier formed on top of the free layer; and
a pinned layer formed on top of the tunnel barrier, and
wherein a state of each of target cells may be determined in a state that an internal magnetic field is generated to reduce a stray field of the target cells among the plurality of variable resistance cells.

12. The physical unclonable function circuit of claim 11, wherein the internal magnetic field is generated by applying a predetermined voltage to an adjacent SOT line, wherein the adjacent SOT line corresponds to a variable resistance cell adjacent to the target cells.

13. The physical unclonable function circuit of claim 11, wherein each of the plurality of variable resistance cells further comprises a digit line below the SOT line, and
wherein the internal magnetic field is generated by applying a voltage to an adjacent digit line, wherein the adjacent digit line corresponds to a variable resistance cell adjacent to the target cells.

14. The physical unclonable function circuit of claim 11, further comprising:
a first switch configured to connect the pinned layer to a corresponding bitline based on a first switch signal during a read operation; and
a second switch configured to connect the SOT line to the corresponding bitline based on a second switch signal during a write operation.

15. The physical unclonable function circuit of claim 14, wherein the SOT line is configured to be shared by at least two of the plurality of variable resistance cells.

16. A security circuit comprising:
a physical unclonable function (PUF) circuit configured to generate a random number; and
a processor configured to generate a key using the random number,
wherein the PUF circuit comprises a PUF block,
wherein the PUF block comprises a plurality of variable resistance cells connected to bitlines, source lines, read wordlines, and write wordlines,
wherein each of the plurality of variable resistance cells comprises:
a Spin-Orbit Torque (SOT) line (SOT line) connected to a corresponding source line among the source lines, wherein the SOT line is configured to be provided with a wordline voltage;
a free layer formed above the SOT line;
a tunnel barrier formed on top of the free layer; and
a pinned layer formed on top of the tunnel barrier, and
wherein a state of each of target cells may be determined in a state that an internal magnetic field is generated to reduce a stray field of the target cells among the plurality of variable resistance cells.

17. The security circuit of claim 16, wherein the PUF block further comprises:
a first switch configured to connect the pinned layer and a corresponding bitline among the bitlines based on to a first switch signal during a read operation; and
a second switch configured to connect the SOT line and the corresponding bitline based on a second switch signal during a write operation.

18. The security circuit of claim 17, wherein the PUF circuit is configured to apply a write voltage to a target SOT line corresponding to the target cells, and to apply a predetermined voltage to an adjacent SOT line corresponding to a variable resistance cell adjacent to the target cells and generate the internal magnetic field, and
wherein the predetermined voltage is smaller than the write voltage.

19. The security circuit of claim 16, wherein at least two of the plurality of variable resistance cells include a shared digit line below the SOT line, and
wherein the PUF circuit is configured to apply a write voltage to a target SOT line corresponding to the target cells, and to apply a voltage to a digit line corresponding to a variable resistance cell adjacent to the target cells and generate the internal magnetic field.

20. The security circuit of claim 16, wherein the PUF circuit is configured to sequentially apply the wordline voltage to the plurality of variable resistance cells in a scan manner and generate the internal magnetic field.

21-25. (canceled)
